(19) United States
(12) Patent Application Publication
(10) Pub. No.: US 2026/0336689 A1
(43) Pub. Date: Oct. 29, 2026

(54) STEERING OSCILLATION DETECTION AND MITIGATION FOR AUTOMATED DRIVING STEERING CONTROL

(71) Applicant: GM GLOBAL TECHNOLOGY OPERATIONS LLC, Detroit, MI (US)

(72) Inventors: Mehdi Abroshan, Whitby (CA); Ashraf Abualfellat, Grand Blanc (CA); Mohammadali Shahriari, Markham (CA); Reza Zarringhalam, Whitby (CA)

(73) Assignee: GM GLOBAL TECHNOLOGY OPERATIONS LLC, Detroit, MI (US)

(21) Appl. No.: 19/187,884

(22) Filed: Apr. 23, 2025

(51) Int. Cl. B62D 5/04; B62D 1/28

(52) U.S. Cl. CPC B62D 5/0472; B62D 1/286

(57) ABSTRACT

In exemplary embodiments, methods and systems are provided for controlling oscillations for automated driving of a vehicle having a steering system including a steering wheel. In one embodiment the system includes one or more sensors of the vehicle and a processor. The one or more sensors are configured to obtain sensor data as to a plurality of operational parameters of the vehicle, including as to a commanded angle of the steering wheel and a measured angle of the steering wheel. The processor is coupled to the one or more sensors, and is configured to at least facilitate determining a measure of oscillation of the vehicle based on the plurality of operational parameters of the vehicle, including based on a difference between the commanded angle of the steering wheel and the measured angle of the steering wheel over a period of time during operation of the vehicle.

### INTRODUCTION

The technical field generally relates to vehicles and, more specifically, to methods and systems for controlling oscillation for automated steering control of vehicles.

Certain vehicles today are equipped with one or more automated driving features, including automated steering control.

Accordingly, it is desirable to provide improved methods and systems for controlling automated steering of vehicles, including for controlling oscillations pertaining thereto. Furthermore, other desirable features and characteristics of the present disclosure will become apparent from the subsequent detailed description and the appended claims, taken in conjunction with the accompanying drawings and the foregoing technical field and background.

### SUMMARY

In accordance with an exemplary embodiment, a method is provided for controlling oscillations for automated driving of a vehicle having a steering system including a steering wheel, the method including obtaining, via one or more sensors of the vehicle, sensor data as to a plurality of operational parameters of the vehicle, including as to a commanded angle of the steering wheel and a measured angle of the steering wheel; and determining, via a processor of the vehicle, a measure of oscillation of the vehicle based on the plurality of operational parameters of the vehicle, including based on a difference between the commanded angle of the steering wheel and the measured angle of the steering wheel over a period of time during operation of the vehicle.

Also in an exemplary embodiment, the oscillations include an unintended vehicle level lateral motion oscillation of the vehicle during automated driving.

Also in an exemplary embodiment, the oscillations include an unintended steering wheel oscillation of the steering wheel of the vehicle during automated driving.

Also in an exemplary embodiment, the measure of oscillation is determined by the processor based on the plurality of operational parameters including each of the following: acceleration of the vehicle, velocity of the vehicle, and respective angles of each of a plurality of wheels of the vehicle in addition to the commanded angle of the steering wheel and the measured angle of the steering wheel over the period of time during operation of the vehicle.

Also in an exemplary embodiment, the measure of oscillation is further determined by the processor based on each of the following: a driver intent; a roughness of a roadway on which the vehicle is operating; a measure of damping for the vehicle; a classification of the oscillations for the vehicle as pertaining to an over-gain controller versus an under-gain controller; and a measure of instability associated with the oscillations.

Also in an exemplary embodiment, the method further includes mitigating the oscillations, in accordance with instructions provided by the processor to a power steering system of the vehicle, by adjusting a control gain of the power steering system based on the measure of oscillation in addition to the classification of the of the oscillations for the vehicle as pertaining to an over-gain controller versus an under-gain controller.

Also in an exemplary embodiment, the method further includes determining, via the processor, that the oscillations pertain to an over-gain controller when the commanded hand wheel angle oscillating consistent with oscillation of the measured hand wheel angle; and an under-grain controller when oscillate approximately the same frequencies and amplitudes but with a time delay that is greater than a predetermined time threshold.

Also in an exemplary embodiment, the mitigation of the oscillations is further performed by the processor based on each of the following: a control impact quantification for the oscillations; a gain impact determination for the oscillations; and a determination as to whether the oscillations are temporary versus permanent in nature.

Also in an exemplary embodiment, the oscillations are determined by the processor to be temporary, when the oscillations are attributed to rough conditions of the roadway, an intent by the driver, or both; and permanent, when the oscillations are determined to be present without rough conditions of the roadway and without an intent by the driver.

In another exemplary embodiment, a system is provided for controlling oscillations for automated driving of a vehicle having a steering system including a steering wheel, the system including one or more sensors of the vehicle and a processor. The one or more sensors are configured to obtain sensor data as to a plurality of operational parameters of the vehicle, including as to a commanded angle of the steering wheel and a measured angle of the steering wheel. The processor is coupled to the one or more sensors, and is configured to at least facilitate determining a measure of oscillation of the vehicle based on the plurality of operational parameters of the vehicle, including based on a difference between the commanded angle of the steering wheel and the measured angle of the steering wheel over a period of time during operation of the vehicle.

Also in an exemplary embodiment, the oscillations include an unintended vehicle level lateral motion oscillation of the vehicle during automated driving.

Also in an exemplary embodiment, the oscillations include an unintended steering wheel oscillation of the steering wheel of the vehicle during automated driving.

Also in an exemplary embodiment, the processor is further configured to at least facilitate determining the measure of oscillation based on the plurality of operational parameters including each of the following: acceleration of the vehicle, velocity of the vehicle, and respective angles of each of a plurality of wheels of the vehicle in addition to the commanded angle of the steering wheel and the measured angle of the steering wheel over the period of time during operation of the vehicle.

Also in an exemplary embodiment, the processor is further configured to at least facilitate determining the measure of oscillation based on each of the following: a driver intent; a roughness of a roadway on which the vehicle is operating; a measure of damping for the vehicle; a classification of the oscillations for the vehicle as pertaining to an over-gain controller versus an under-gain controller; and a measure of instability associated with the oscillations.

Also in an exemplary embodiment, the processor is further configured to at least facilitate mitigating the oscillations, in accordance with instructions provided by the processor to a power steering system of the vehicle, by adjusting a control gain of the power steering system based on the measure of oscillation in addition to the classification of the of the oscillations for the vehicle as pertaining to an over-gain controller versus an under-gain controller.

Also in an exemplary embodiment, the processor is further configured to at least facilitate determining that the oscillations pertain to an over-gain controller when the commanded hand wheel angle oscillating consistent with oscillation of the measured hand wheel angle; and an under-grain controller when oscillate approximately the same frequencies and amplitudes but with a time delay that is greater than a predetermined time threshold.

Also in an exemplary embodiment, the processor is further configured to at least facilitate mitigation of the oscillations based on each of the following: a control impact quantification for the oscillations; a gain impact determination for the oscillations; and a determination as to whether the oscillations are temporary versus permanent in nature.

Also in an exemplary embodiment, the processor is further configured to at least facilitate determining the oscillations to be temporary, when the oscillations are attributed to rough conditions of the roadway, an intent by the driver, or both; and permanent, when the oscillations are determined to be present without rough conditions of the roadway and without an intent by the driver.

In another exemplary embodiment, a vehicle is provided that includes a body, a plurality of wheels, a drive system, a steering system, one or more sensors, and a processor. The drive system is configured to move the body via the plurality of wheels. The steering system includes a steering wheel, and is coupled to the plurality of wheels. The one or more sensors are configured to obtain sensor data as to a plurality of operational parameters of the vehicle, including as to a commanded angle of the steering wheel, a measured angle of the steering wheel, an acceleration of the vehicle; a velocity of the vehicle; and respective angles of each of the plurality of wheels. The processor is coupled to the one or more sensors, and is configured to at least facilitate determining a measure of oscillation of the vehicle based on the plurality of operational parameters of the vehicle, including based each of the following: the acceleration of the vehicle; the velocity of the vehicle; the respective angles of each of the plurality of wheels; the commanded angle of the steering wheel; and the measured angle of the steering wheel over the period of time during operation of the vehicle, including based on a difference between the commanded angle of the steering wheel and the measured angle of the steering wheel over a period of time during operation of the vehicle, wherein the oscillations include an unintended vehicle level lateral motion oscillation of the vehicle during automated driving, an unintended steering wheel oscillation of the steering wheel of the vehicle during automated driving, or both. The processor is further configured to at least facilitate determining the measure of oscillation based on each of the following: a driver intent; a roughness of a roadway on which the vehicle is operating; a measure of damping for the vehicle; a classification of the oscillations for the vehicle as pertaining to an over-gain controller versus an under-gain controller; and a measure of instability associated with the oscillations.

Also in an exemplary embodiment, the processor is further configured to at least facilitate determining that the oscillations pertain to an over-gain controller when the commanded hand wheel angle oscillating consistent with oscillation of the measured hand wheel angle; and an under-grain controller when oscillate approximately the same frequencies and amplitudes but with a time delay that is greater than a predetermined time threshold; and mitigating the oscillations, in accordance with instructions provided by the processor to a power steering system of the vehicle, by adjusting a control gain of the power steering system based on the measure of oscillation in addition to the classification of the of the oscillations for the vehicle as pertaining to an over-gain controller versus an under-gain controller; wherein the processor is further configured to at least facilitate determining the oscillations to be temporary, when the oscillations are attributed to rough conditions of the roadway, an intent by the driver, or both; and permanent, when the oscillations are determined to be present without rough conditions of the roadway and without an intent by the driver; and wherein the processor is further configured to at least facilitate mitigation of the oscillations based on each of the following: a control impact quantification for the oscillations; a gain impact determination for the oscillations; and a determination as to whether the oscillations are temporary versus permanent in nature.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for automated vehicle control, including for controlling automated steering and oscillation pertaining thereto, in accordance with exemplary embodiments;

FIG. 2 is a flow diagram of a process for controlling automated steering and oscillation pertaining thereto, and that can be implemented in connection with the vehicle and control system of FIG. 1, in accordance with exemplary embodiments; and

FIGS. 3-6 depict exemplary implementations of the process of FIG. 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

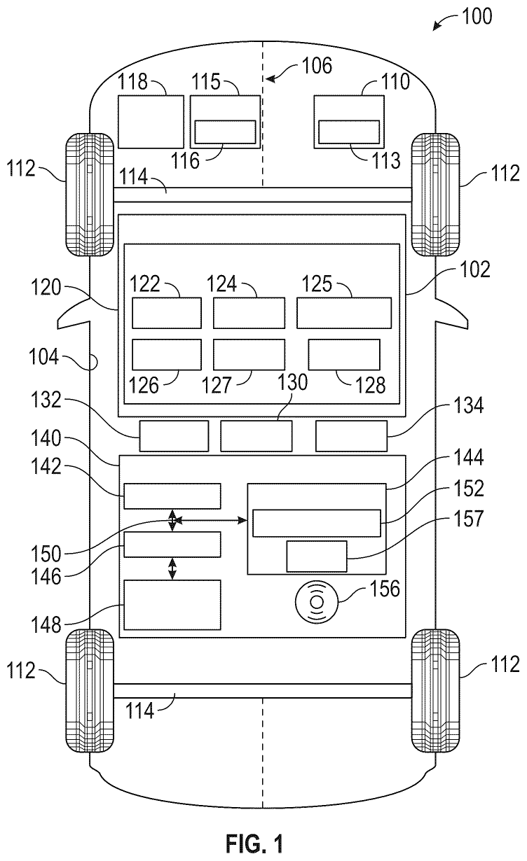

FIG. 1 illustrates a vehicle 100, according to an exemplary embodiment. As described in greater detail further below, the vehicle 100 includes a control system 102 that is configured for automated vehicle control, including for controlling automated steering and oscillation pertaining thereto for the vehicle 100, in accordance with exemplary embodiments.

In various embodiments, the vehicle 100 includes an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise another type of vehicle, such as aircraft, spacecraft, watercraft, and so on.

The vehicle 100 includes a body 104 that is arranged on a chassis 106. The body 104 substantially encloses other components of the vehicle 100. The body 104 and the chassis 106 may jointly form a frame. The vehicle 100 also includes a plurality of wheels 112. The wheels 112 are each rotationally coupled to the chassis 106 near a respective corner of the body 104 to facilitate movement of the vehicle 100. In one embodiment, the vehicle 100 includes four wheels 112, although this may vary in other embodiments (for example for trucks and certain other vehicles).

As depicted in FIG. 1, in exemplary embodiments, a drive system 110 is mounted on the chassis 106, and drives the wheels 112, for example via axles 114. In certain embodiments, the drive system 110 comprises a propulsion system. In certain exemplary embodiments, the drive system 110 comprises a motor 113, such as an internal combustion engine and/or an electric motor/generator, coupled with a transmission thereof. In certain embodiments, the drive system 110 may vary, and/or two or more drive systems 110 may be used. Also in exemplary embodiments, the drive system 110 controls propulsion of the vehicle 100 in accordance with via inputs provided by a driver (i.e., via an accelerator pedal) and/or automatically via instructions provided by the control system 102.

As depicted in FIG. 1, the vehicle includes a steering system 115 that controls steering of the vehicle 100. In various embodiments, the steering system 115 controls steering of the vehicle 100 via steering components, for example that including a steering column that is coupled to the axles 114 and/or the wheels 112, and that is controlled in various circumstances automatically via the control system 102, and in certain instances also via inputs provided by a driver via a steering wheel 116.

In exemplary embodiments, the vehicle 100 also includes a braking system 118 that controls braking of the vehicle 100 using braking components that are controlled via inputs provided by a driver (e.g., via a brake pedal) and/or that are also automatically controlled via the control system 102.

In the embodiment depicted in FIG. 1, the control system 102 is coupled to the steering system 115. In certain embodiments, the control system 102 may also be coupled to the drive system 110, the braking system 118, and/or one or more other vehicle systems and/or components.

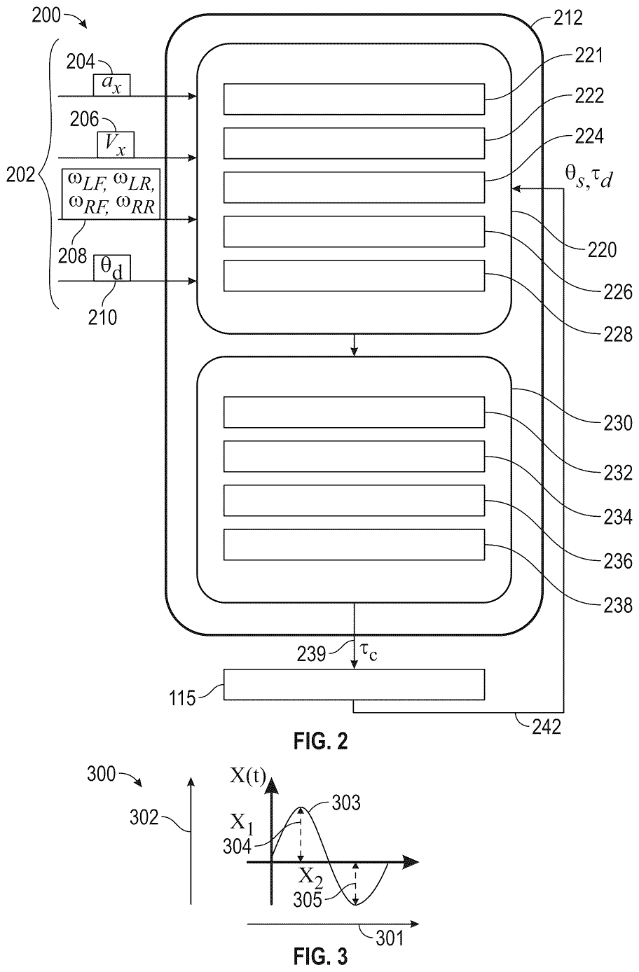

In various embodiments, as noted above, the control system 102 controls automated vehicle control, including for controlling automated steering for the vehicle 100. In various embodiments, the control system 102 controls automated steering in manner that controls oscillation for the vehicle 100, including by detecting and mitigating oscillation for the vehicle 100 pertaining to the steering system 115. In various embodiments, the control system 102 performs these features in accordance with the process 200 of FIG. 2 and the implementations of FIGS. 3-6.

As depicted in FIG. 1, in various embodiments, the control system 102 includes a sensor array 120 and a controller 140, as described in greater detail below. Also as depicted in FIG. 1, in various embodiments the control system 102 also includes a display system 130, a transceiver 132, and a location system 134, also as described in greater detail below.

In various embodiments, the sensor array 120 includes various sensors that obtain sensor data as to the vehicle 100, including for use in detecting and mitigation oscillation for the vehicle 100 pertaining to the steering system 115. In the depicted embodiment, the sensor array 120 includes on or more input sensors 122, steering sensors 124, detection sensors 125, velocity sensors 126, and acceleration sensors 127. In certain embodiments, the sensor array 120 may also include one or more other sensors 128.

In various embodiments, the one or more input sensors 122 receive inputs from a driver of the vehicle 100. In certain embodiments, the inputs include the driver's engagement of the steering wheel 116. In certain embodiments, the inputs may also include the driver's activation or deactivation of automated steering control, a desired destination and/or route of travel for the vehicle, inputs as to the driver's engagement of an accelerator pedal, brake pedal, and/or other device and/or system of the vehicle 100, and so on.

In various embodiments, the one or more steering sensors 124 obtain steering sensor data. In certain embodiments, the steering sensors 124 measure positions and/or angles of the steering wheel 116 and/or one or more other steering angles (such as angles of the wheels 112, a steering column and/or other component of the steering system 115, or the like). In certain embodiments, the steering sensors 124 may also measure a driver's engagement of the steering wheel 116 (e.g., such sensors may also relate to input sensors 122 in certain embodiments and circumstances).

In various embodiments, the one or more detection sensors 125 comprise one or more exterior cameras, radar, Lidar, sonar, infrared, and/or other detection sensors that are configured to obtain camera images and/or other detection sensor as to an environment surrounding the vehicle 100, including a terrain of a roadway or other path on which the vehicle 100 is travelling.

In various embodiments, the one or more velocity sensors 126 comprise one or more velocity and/or speed sensors of the vehicle 100, such as wheel speed sensors in certain embodiments. Also in various embodiments, the one or more acceleration sensors 127 comprise one or more accelerometers of the vehicle 100 (while in certain embodiments data from the velocity sensors 126 may also be used to calculate acceleration for the vehicle 100).

In addition, in certain embodiments the sensor array 120 may also include one or more other sensors 128, such as one or more gyroscopes and/or other others configured to obtain sensor data as to road conditions and/or other environmental and/or vehicle parameters.

In certain embodiments, the display system 130 is configured to provide information, instructions, queries, alerts, settings, status, displays, and related information for the driver, including pertaining to automated driving, including automated steering and oscillations pertaining thereto. In various embodiments, the display system 130 includes a visual component including a display screen that provides visual notifications for the driver. In certain embodiments, the display system 130 may also include one or more audio components (e.g., including a speaker) that provides an audio notifications for the driver and/or one or more other components, such as a haptic component that provides one or more haptic notifications for the driver (e.g., by vibrating a seat of the driver).

In certain embodiments, the transceiver 132 is configured to communicate with one or more remote servers and/or remote service provides via one or more wireless networks, for example including as to road conditions in proximity the vehicle 100.

In certain embodiments, the location system 134 obtains information as to a geographic location of the vehicle 100. In certain embodiments, the location system 134 comprises and/or is part of or coupled to a satellite-based system, such as a global positioning system (GPS) as part of a navigation system for the vehicle 100.

In various embodiments, the controller 140 is coupled to the sensor array 120 and the steering system 115. In certain embodiments, the controller 140 is also coupled to the drive system 110, the braking system 118, the display system 130, the transceiver 132, the location system 134, and/or one or more other vehicle systems. Also in various embodiments, the controller 140 comprises a computer system (also referred to herein as computer system 140), and includes a processor 142, a memory 144, an interface 146, a storage device 148, and a computer bus 150. In various embodiments, the controller (or computer system) 140 provides, among other functionality, for automated vehicle control, including for controlling automated steering and oscillation pertaining thereto for the vehicle 100. In various embodiments, the controller 140 provides these and other functions in accordance with the steps of the process 200 of FIG. 2 and the implementations of FIGS. 3-6.

In various embodiments, the controller 140 (and, in certain embodiments, the control system 102 itself) is disposed within the body 104 of the vehicle 100. In one embodiment, the control system 102 is mounted on the chassis 106. In certain other embodiments, the controller 140 and/or control system 102 and/or one or more components thereof may be disposed outside the body 104, for example on a remote server, in the cloud, or other device.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In various embodiments, the processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process 200 of FIG. 2 and the implementations of FIGS. 3-6.

The memory 144 can be any type of suitable memory. For example, the memory 144 may include various types of dynamic random access memory (DRA M) such as synchronous dynamic random access memory (SDRAM), the various types of static RAM (SRAM), and the various types of non-volatile memory, such as programmable read-only memory (PROM) and flash. In certain examples, the memory 144 is located on and/or co-located on the same computer chip as the processor 142. In the depicted embodiment, the memory 144 stores the above-referenced program 152 along with stored values 157 (e.g., threshold values for the process 200 of FIG. 2 and the implementations of FIGS. 3-6 in various embodiments).

The interface 146 allows communication to the computer system of the controller 140, for example from a system driver and/or another computer system, and can be implemented using any suitable method and apparatus. In one embodiment, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 200 of FIG. 2 and the implementations of FIGS. 3-6. In another exemplary embodiment, the program product may be directly stored in and/or otherwise accessed by the memory 144 and/or a disk (e.g., disk 156), such as that referenced below.

The bus 150 serves to transmit programs, data, status and other information or signals between the various components of the computer system of the controller 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

FIG. 2 is a flowchart of a process 200 for controlling automated steering and oscillation pertaining thereto, in accordance with an exemplary embodiment. In various embodiments, the process 200 can be implemented in connection with the vehicle 100 and control system 102 of FIG. 1. The process 200 is described below in connection with FIGS. 3-6, which depict exemplary implementations of the process 200.

In various embodiments, the process 200 begins when the vehicle 100 is turned on in operational mode (e.g., on a vehicle drive). In one embodiment, the steps of the process 200 are performed continuously while the driver is inside the vehicle and/or during operation of the vehicle.

As depicted in FIG. 2, in various embodiments data is obtained (step 202). In various embodiments, sensor data is obtained during step 202 from the sensor array 120 of FIG. 1 (and in certain embodiments also via the location system 134 and/or transceiver 132 of FIG. 1). In various embodiments, the sensor data includes: (i) an acceleration 204 of the vehicle (aₓ); (ii) a velocity 205 of the vehicle (Vₓ); (iii) steering angle values 208 of the vehicle, including a left front steering angle (ω_{LF}), a left rear steering angle (ω_{LR}), a right front steering angle (ω_{RF}), and a right rear steering angle (ω_{RR}) of various respective wheels 112 of the vehicle; and (iv) a hand wheel angle, or steering wheel angle (θ), corresponding to the steering wheel 116 of FIG. 1). In various embodiments, additional sensor data is also obtained as part of step 202, including measures of road roughness, driver inputs, and so on.

In various embodiments, the data of step 202 is utilized in a steering performance monitor 212 of the process 200. Specifically, in various embodiments, the data of step 202 is utilized first for oscillation detection 220 (corresponding to steps 222-228, described directly below) as well as for oscillation mitigation 230 (corresponding to steps 232-238, described further below). In certain various embodiments, as used throughout this Application, the term “oscillation” refers to unintended lateral motion oscillations in automated driving, unintentional steering wheel oscillations in automated driving, or both.

In various embodiments, as part of the oscillation detection 220, driver intent detection is performed (step 221). In various embodiments, the processor 142 of FIG. 1 determines an intent of the driver with respect to the steering wheel 116 of FIG. 1, including for determining whether any oscillation of the steering wheel 116 is due to the driver's intent (e.g., in manually steering the vehicle 100). In various embodiments, this is determined by data from the input sensors 122 and/or steering sensors 124 of FIG. 1, for example as the driver's engagement of the steering wheel as part of step 202. In various embodiments, the driver intent is determined separately for each half cycle, and is stored in a buffer (e.g., as part of the stored values 157 of the memory 144 of FIG. 1).

Also in various embodiments, road roughness detection is performed (step 222). In various embodiments, the processor 142 of FIG. 1 determines a measure of roughness (e.g., in terms of an uneven surface, such as from potholes and speed bumps, and/or other anomalies of a roadway or other path on which the vehicle 100 is being driven, including for determining whether any oscillation of the steering wheel 116 is due to the roughness of the roadway. In various embodiments, this is determined by data from the detection sensors 125 (and/or in certain embodiments other sensors 128) of FIG. 1 as part of step 202. In various embodiments, the road roughness is determined separately for each half cycle, and is stored in a buffer (e.g., as part of the stored values 157 of the memory 144 of FIG. 1).

Also in various embodiments, damping monitoring is performed (step 224). In various embodiments, the damping monitoring is performed by the processor 142 based on data from the steering sensors 124 of FIG. 1 as part of step 202. Specifically, in various embodiments, the processor 142 of FIG. 1 determines an estimation of the damping “ [symbol] ” of the steering system 115 for each half cycle in accordance with the following equations:

x=θᵣ−θₛ (Equation 1);

$${Δ}_{1} = ln \vert \frac{{x}_{1}}{{x}_{2}} \vert$$

### Equation 2); and

$${\text{?}}_{1} = \frac{{Δ}_{1}}{\sqrt{{π}^{2} + {Δ}_{1}^{2}}} , \qquad ( Equation 3 )$$

in which:
“x” represents the hand wheel angle (HWA) error with respect to the steering wheel 116 (also referred to as a “steering wheel angle”);
“θr” and “θs” represent the commanded and measured hand wheel angles;
“x₁” and “x₂” represent the respective HWA error peaks in consecutive half cycles of oscillations; and
“ [symbol] ₁” represents the estimated damping at point in time “1”.

With reference to FIG. 3, in an exemplary the half cycle is represented in the illustration 300. In an exemplary embodiment, the illustration 300 includes an x-axis 301 representing time (t) (e.g., in seconds), and the y-axis 302 represents HWA error x(t). As shown in FIG. 3, an exemplary function 303 of the HWA error over time, x(t), is provided. In the illustration respective error values x₁ (304) and x₂ (305) (e.g., also corresponding to amplitudes of the function 303 of the HWA error over time, x(t)).

With reference back to FIG. 2, in various embodiments, oscillation classification is performed (step 226). In various embodiments, the oscillation classification is also performed by the processor 142 based on data from the steering sensors 124 of FIG. 1 as part of step 202. Specifically, in various embodiments, the processor 142 of FIG. 1 determines a classification of the hand wheel oscillation as either having over-gained or under-gained controllers, and identifies the key characteristics of each category including an amplitude θₑ and an oscillation time-period Tₒ.

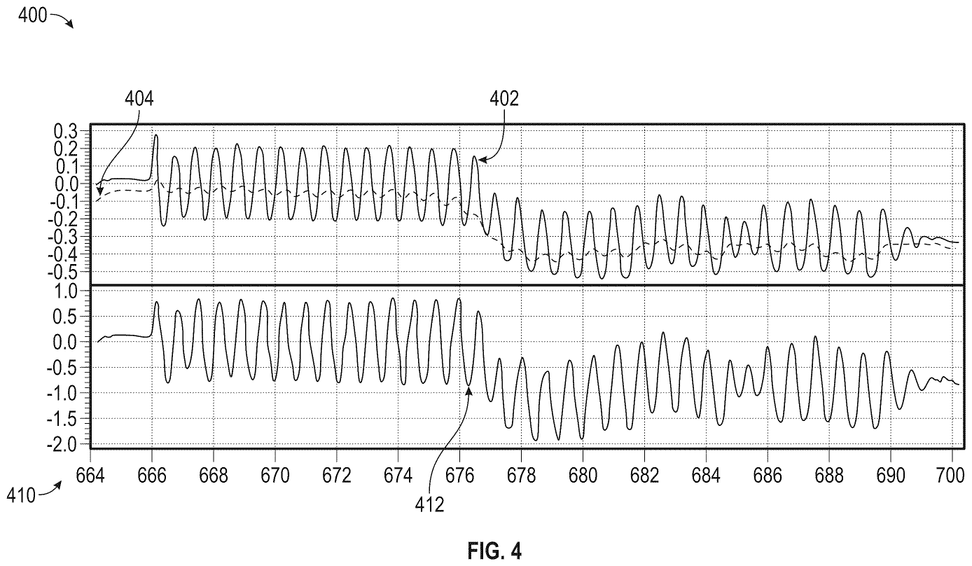

With reference to FIG. 4, an exemplary implementation is provided for oscillation classification of step 226 with respect to the scenario of an over-gain controller. Specifically, as depicted in FIG. 4 in accordance with an exemplary embodiment: (i) a first illustration 400 is provided showing both measured hand wheel angle 402 and commanded hand wheel angle 404 as a function of time; and (ii) a second illustration 410 is provided showing vehicle lateral acceleration 412 as a function of time. As shown in FIG. 4, in the scenario of an over-gain controllers, the commanded hand wheel angle 404 is not oscillating significantly compared to the measured hand wheel angle 402. Also in the depicted embodiment, the time-period of oscillations range from one half second to two seconds (i.e., 0.5-2 sec) in this implementation.

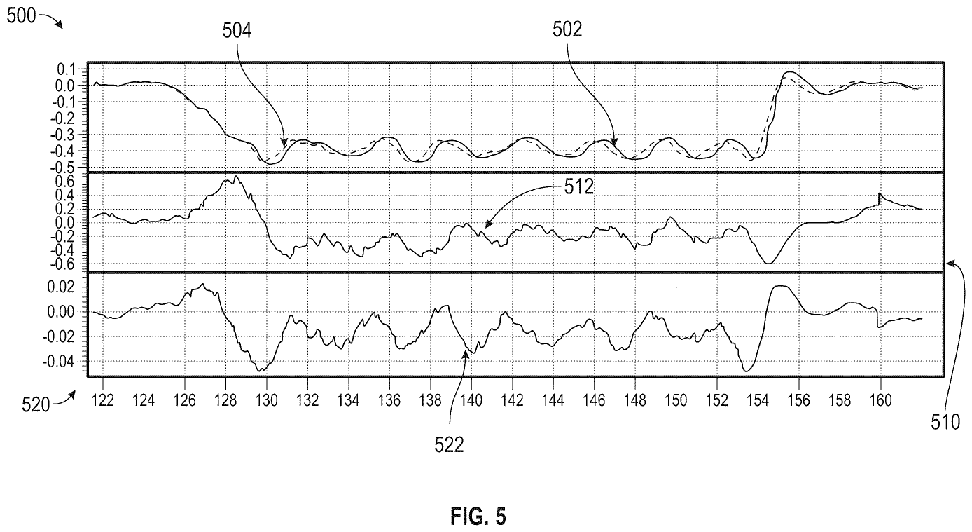

With reference to FIG. 5, an exemplary implementation is provided for oscillation classification of step 226 with respect to the scenario of an under-gain controller. Specifically, as depicted in FIG. 5 in accordance with an exemplary embodiment: (i) a first illustration 500 is provided showing both measured hand wheel angle 502 and commanded hand wheel angle 504 as a function of time; and (ii) a second illustration 510 is provided showing lateral deviation 512 from a target path for the vehicle over time; and (iii) a third illustration 520 is provided showing error 522 with respect to the target path as a function of time. As shown in FIG. 5, in the scenario of an under-gain controllers, both the commanded hand wheel angle 504 and the measured hand wheel angle 502 oscillate relatively with the same frequency and amplitude (i.e., with frequency and amplitude differences that are both less than respective thresholds), but with a significant large time delay (e.g., with a time delay that is greater than a predetermined time threshold). In one such embodiment, the time period of oscillations in this controller ranges is from four seconds (4 sec) to eight seconds (8 sec). Also in one such embodiment, the vehicle 100 also oscillates with the same frequency.

With reference back to FIG. 2, in various embodiments, instability detection is performed (step 228). In various embodiments, the oscillation classification is performed based on the prior determinations, including of the damping monitoring of step 224 and the oscillation classification of step 226. Specifically, in various embodiments, the processor 142 of FIG. 1 determines instability based on whether the damping less than a predetermined damping threshold for at least a predetermined number of consecutive half-cycle oscillations. In certain embodiments, instability is determined to occur when the damping is less than the predetermined damping thresholds for at least three consecutive half-cycle oscillations.

In certain embodiments, low damping is determined in accordance with the following equation;

|θₑ|₁<|θₑ|₂→Low damping (Equation 4); and

|θₑ|₂>>|θₑ|₃→High damping (Equation 5),
in which “θₑ” represents the hand wheel angle (HWA) error values at respective times one (1), two (2), and three (3), and the absolute values of each are utilized in accordance with the equations above.

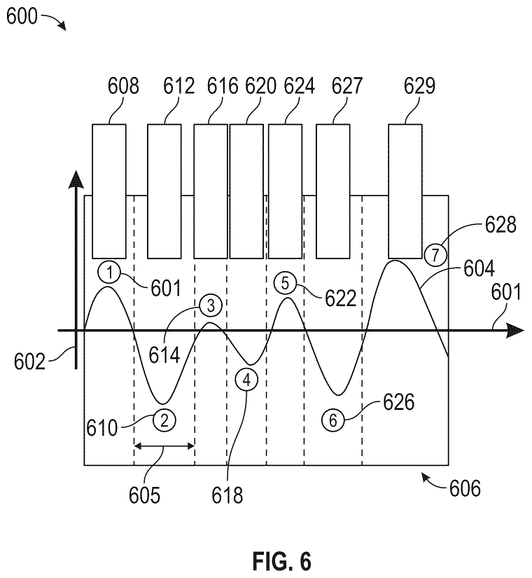

With reference to FIG. 6, an exemplary illustration 600 is provided with respect to instability detection in accordance with one particular implementation. In FIG. 6, the x-axis 601 represents time, and the y-axis 602 represents HWA error (Pe). A function 604 of the HWA error (Pe) over time is depicted in FIG. 6, along with a buffer. In the depicted implementation of FIG. 6, (i) a first amplitude value 607 represents a low damping region 608; (ii) a second amplitude value 610 (as part of a time window 605) represents a high damping region 612; (iii) a third amplitude value 614 represents a low damping region 616; (iv) a fourth amplitude value 618 represents a low damping region 620; (v) a fifth amplitude value 622 represents a low damping region 624; (vi) a sixth amplitude value 626 represents a low damping region 627; and (vii) a seventh amplitude value 628 represents a low damping region 629. In the example of FIG. 6, because low damping occurred in at least three consecutive half cycle oscillations, instability is determined to be present for this particular scenario.

With reference back to FIG. 2, in various embodiments, once oscillation detection 220 is determined in steps 221-228 as described above, the process 200 then proceeds with oscillation mitigation 230 in accordance with steps 232-238 described directly below.

In various embodiments, during step 232, control impact quantification is performed. In various embodiments, the processor 142 of FIG. 1 determines a quantified measure of the control impact of the oscillation based on the various determinations of steps 221-228 as described above.

Also in various embodiments, during step 234, gain adaptation is performed. In various embodiments, the processor 142 of FIG. 1 determines the gain adaptation differently based on whether the situation involves an over-gain controller versus an under-gain controller (i.e., according to the oscillation classification that has previously been performed in step 236 and as described above in connection therewith).

In various embodiments, during step 234, in the case of an over-gain controller, the controller gains are modified in order to damp the oscillations. In certain such embodiments, proportional gains are applied in this manner. Specifically, in certain embodiments with an over-gain controller, the modification level “K^{OG}” for the gain is dependent upon vehicle speed (Vₓ) target path curvature ρ_{Pt}), and average HWA error amplitude in buffer, |θₑ|^{a}, in accordance with the following equation:

K^{OG}=F(Vₓ,ρₜ,|θₑ|^{a}) (Equation 6).

Conversely, in various embodiments, during step 234, in the case of an under-gain controller, the modification level “K^{UG}” for the gain is dependent upon vehicle speed (Vₓ) target path curvature (ρₜ), average HWA error amplitude in buffer, |θₑ|^{a}, and time-delay at crossing zero, Δφ in accordance with the following equation:

K^{UG}=F(Vₓ,ρₜ,|θₑ|^{a},Δφ) (Equation 7).

Also in various embodiments, during step 236, in appropriate situations a temporary adjustment is made for the controller gains. In certain embodiments, the processor 142 applies temporary adjustments to the controller gains in situations, such as in which rough road conditions (e.g., speed bumps or potholes) or driver intent (e.g., driver engagement of the steering wheel) are believed to be a significant cause of the oscillations, and therefore in which the controller gains are determined to be due to one or more short lived conditions.

Specifically, in various embodiments in which a temporary adjustment is made for the controller gains in step 236, the processor 142 updates the controller gain is updated using the following equation:

Pₙ=Pₒ(1+K^{UG}−K^{OG}) (Equation 8), in which:
“Pₙ” represents the updated gain “P”; and
“Pₒ” represents the original “P” gain.

In various embodiments, the updated gain of step 236 gradually converges to the original gain in accordance with Equation 8 when the oscillations are damped.

Conversely, in various embodiments, during step 238, in other appropriate situations a permanent adjustment is made for the controller gains. In certain embodiments, the processor 142 applies permanent adjustments to the controller gains in situations, such as an issue with or permanent change in the control system 102, in which the controller gains are determined to be due to one or more permanent or longer term conditions.

Specifically, in various embodiments, such a permanent condition is deemed to be present when the driver (or driver intent) did not cause the oscillations, and in which the oscillations did not happen on rough roads (e.g., with speed bumps, potholes, or the like). In certain such embodiments, when the oscillations occur frequently and show up after each temporary adjustment event, the problem is considered as a steering system specification change. In such situations, the controller gains are updated permanently to solve this issue. In certain embodiments, the request for permanent controller gain adjustment is made when the number of temporary adjustment events exceed a predetermined threshold along with the following conditions being satisfied: (i) the driver did not cause the oscillations; and (ii) the oscillations did not happen on rough roads.

In certain embodiments, for the permanent adjustment of step 238, the permanent gain

$$“ {K}_{n}^{U G / O G} ”$$

is calculated by the processor 142 as being the average of all previous modification gains (e.g., in certain embodiments, all of the previous temporary modification gains), in accordance with the following equation:

$${K}_{n}^{U G / O G} = \frac{{Σ}_{i = 1}^{k} {K}^{U G / O G}}{k} . \qquad ( Equation 9 )$$

In various embodiments, the torque mitigation is provided accordingly by the processor 142 at step 239 by providing a torque adjustment “τ” to a power steering system (i.e., corresponding to the steering system 115 of FIG. in an exemplary embodiment). Also in various embodiments, resulting updated torque “τ” and hand wheel angle “θ” values are provided accordingly to the oscillation detection 220 as the process 200 continues, beginning with step 221, in a new iteration, and as the process 200 thereafter repeats in the new iteration.

Accordingly, methods, systems, and vehicles are disclosed for controlling automated steering and oscillations pertaining thereto for vehicles. Specifically, in various embodiments, a processor of the vehicle utilizes various different types of sensor data in performing both oscillation detection as well as temporary and permanent mitigation of the steering system oscillation in appropriate circumstances.

It will be appreciated that the systems, vehicles, and methods may vary from those depicted in the Figures and described herein. For example, the vehicle 100 of FIG. 1, the control system 102 of FIG. 1, and/or components thereof may vary in different embodiments. It will similarly be appreciated that the steps of the process 200 may differ from that depicted in FIGS. 2, and/or that various steps of the process 200 may occur concurrently and/or in a different order than that depicted in FIG. 2. It will also be appreciated that the implementations of FIGS. 3-6 may also vary in different embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling oscillations for automated driving of a vehicle having a steering system including a steering wheel, the method comprising:
obtaining, via one or more sensors of the vehicle, sensor data as to a plurality of operational parameters of the vehicle, including as to a commanded angle of the steering wheel and a measured angle of the steering wheel; and
determining, via a processor of the vehicle, a measure of oscillation of the vehicle based on the plurality of operational parameters of the vehicle, including based on a difference between the commanded angle of the steering wheel and the measured angle of the steering wheel over a period of time during operation of the vehicle.

2. The method of claim 1, wherein the oscillations comprise an unintended vehicle level lateral motion oscillation of the vehicle during automated driving.

3. The method of claim 1, wherein the oscillations comprise an unintended steering wheel oscillation of the steering wheel of the vehicle during automated driving.

4. The method of claim 1, wherein the measure of oscillation is determined by the processor based on the plurality of operational parameters including each of the following: acceleration of the vehicle, velocity of the vehicle, and respective angles of each of a plurality of wheels of the vehicle in addition to the commanded angle of the steering wheel and the measured angle of the steering wheel over the period of time during operation of the vehicle.

5. The method of claim 1, wherein the measure of oscillation is further determined by the processor based on each of the following:
a driver intent;
a roughness of a roadway on which the vehicle is operating;
a measure of damping for the vehicle;
a classification of the oscillations for the vehicle as pertaining to an over-gain controller versus an under-gain controller; and
a measure of instability associated with the oscillations.

6. The method of claim 5, further comprising:
mitigating the oscillations, in accordance with instructions provided by the processor to a power steering system of the vehicle, by adjusting a control gain of the power steering system based on the measure of oscillation in addition to the classification of the of the oscillations for the vehicle as pertaining to an over-gain controller versus an under-gain controller.

7. The method of claim 6, further comprising:
determining, via the processor, that the oscillations pertain to:
an over-gain controller when the commanded hand wheel angle oscillating consistent with oscillation of the measured hand wheel angle; and
an under-grain controller when oscillate approximately the same frequencies and amplitudes but with a time delay that is greater than a predetermined time threshold.

8. The method of claim 6, wherein the mitigation of the oscillations is further performed by the processor based on each of the following:
a control impact quantification for the oscillations;
a gain impact determination for the oscillations; and
a determination as to whether the oscillations are temporary versus permanent in nature.

9. The method of claim 8, wherein the oscillations are determined by the processor to be:
temporary, when the oscillations are attributed to rough conditions of the roadway, an intent by the driver, or both; and
permanent, when the oscillations are determined to be present without rough conditions of the roadway and without an intent by the driver.

10. A system for controlling oscillations for automated driving of a vehicle having a steering system including a steering wheel, the system comprising:
one or more sensors of the vehicle that are configured to obtain sensor data as to a plurality of operational parameters of the vehicle, including as to a commanded angle of the steering wheel and a measured angle of the steering wheel; and
a processor that is coupled to the one or more sensors and that is configured to at least facilitate determining a measure of oscillation of the vehicle based on the plurality of operational parameters of the vehicle, including based on a difference between the commanded angle of the steering wheel and the measured angle of the steering wheel over a period of time during operation of the vehicle.

11. The system of claim 10, wherein the oscillations comprise an unintended vehicle level lateral motion oscillation of the vehicle during automated driving.

12. The system of claim 10, wherein the oscillations comprise an unintended steering wheel oscillation of the steering wheel of the vehicle during automated driving.

13. The system of claim 10, wherein the processor is further configured to at least facilitate determining the measure of oscillation based on the plurality of operational parameters including each of the following: acceleration of the vehicle, velocity of the vehicle, and respective angles of each of a plurality of wheels of the vehicle in addition to the commanded angle of the steering wheel and the measured angle of the steering wheel over the period of time during operation of the vehicle.

14. The system of claim 10, wherein the processor is further configured to at least facilitate determining the measure of oscillation based on each of the following:
a driver intent;
a roughness of a roadway on which the vehicle is operating;
a measure of damping for the vehicle;
a classification of the oscillations for the vehicle as pertaining to an over-gain controller versus an under-gain controller; and
a measure of instability associated with the oscillations.

15. The system of claim 14, wherein the processor is further configured to at least facilitate:
mitigating the oscillations, in accordance with instructions provided by the processor to a power steering system of the vehicle, by adjusting a control gain of the power steering system based on the measure of oscillation in addition to the classification of the of the oscillations for the vehicle as pertaining to an over-gain controller versus an under-gain controller.

16. The method of claim 15, wherein the processor is further configured to at least facilitate determining that the oscillations pertain to:
an over-gain controller when the commanded hand wheel angle oscillating consistent with oscillation of the measured hand wheel angle; and
an under-grain controller when oscillate approximately the same frequencies and amplitudes but with a time delay that is greater than a predetermined time threshold.

17. The system of claim 15, wherein the processor is further configured to at least facilitate mitigation of the oscillations based on each of the following:
a control impact quantification for the oscillations;
a gain impact determination for the oscillations; and
a determination as to whether the oscillations are temporary versus permanent in nature.

18. The system of claim 17, wherein the processor is further configured to at least facilitate determining the oscillations to be:
temporary, when the oscillations are attributed to rough conditions of the roadway, an intent by the driver, or both; and
permanent, when the oscillations are determined to be present without rough conditions of the roadway and without an intent by the driver.

19. A vehicle comprising:
a body;
a plurality of wheels;
a drive system configured to move the body via the plurality of wheels;
a steering system including a steering wheel and that is coupled to the plurality of wheels;
one or more sensors that are configured to obtain sensor data as to a plurality of operational parameters of the vehicle, including as to a commanded angle of the steering wheel, a measured angle of the steering wheel, an acceleration of the vehicle; a velocity of the vehicle; and respective angles of each of the plurality of wheels; and
a processor that is coupled to the one or more sensors and that is configured to at least facilitate:
determining a measure of oscillation of the vehicle based on the plurality of operational parameters of the vehicle, including based each of the following:
the acceleration of the vehicle;
the velocity of the vehicle;
the respective angles of each of the plurality of wheels;
the commanded angle of the steering wheel; and
the measured angle of the steering wheel over the period of time during operation of the vehicle, including based on a difference between the commanded angle of the steering wheel and the measured angle of the steering wheel over a period of time during operation of the vehicle, wherein the oscillations comprise an unintended vehicle level lateral motion oscillation of the vehicle during automated driving, an unintended steering wheel oscillation of the steering wheel of the vehicle during automated driving, or both; and
wherein the processor is further configured to at least facilitate determining the measure of oscillation based on each of the following:
a driver intent;
a roughness of a roadway on which the vehicle is operating;
a measure of damping for the vehicle;
a classification of the oscillations for the vehicle as pertaining to an over-gain controller versus an under-gain controller; and
a measure of instability associated with the oscillations.

20. The vehicle of claim 19, wherein the processor is further configured to at least facilitate:
determining that the oscillations pertain to:
an over-gain controller when the commanded hand wheel angle oscillating consistent with oscillation of the measured hand wheel angle; and
an under-grain controller when oscillate approximately the same frequencies and amplitudes but with a time delay that is greater than a predetermined time threshold; and
mitigating the oscillations, in accordance with instructions provided by the processor to a power steering system of the vehicle, by adjusting a control gain of the power steering system based on the measure of oscillation in addition to the classification of the of the oscillations for the vehicle as pertaining to an over-gain controller versus an under-gain controller;
wherein the processor is further configured to at least facilitate determining the oscillations to be:
temporary, when the oscillations are attributed to rough conditions of the roadway, an intent by the driver, or both; and
permanent, when the oscillations are determined to be present without rough conditions of the roadway and without an intent by the driver; and
wherein the processor is further configured to at least facilitate mitigation of the oscillations based on each of the following:
a control impact quantification for the oscillations;
a gain impact determination for the oscillations; and
a determination as to whether the oscillations are temporary versus permanent in nature.
